(19) United States
(12) Patent Application Publication
(10) Pub. No.: US 2023/0152534 A1
(43) Pub. Date: May 18, 2023

(54) OPTICAL CONNECTOR, FERRULE, AND METHOD FOR MANUFACTURING OPTICAL CONNECTOR

(71) Applicant: SUMITOMO ELECTRIC INDUSTRIES, LTD., Osaka-shi, Osaka (JP)

(72) Inventors: Sho YAKABE, Osaka-shi (JP); Yuto FUJIHARA, Osaka-shi (JP)

(73) Assignee: SUMITOMO ELECTRIC INDUSTRIES, LTD., Osaka-shi, Osaka (JP)

(21) Appl. No.: 17/913,630

(22) PCT Filed: Feb. 17, 2021
(86) PCT No.: PCT/JP2021/005913

§ 371 Date: Sep. 22, 2022

(30) Foreign Application Priority Data
Apr. 10, 2020 (JP) 2020-070809

(51) Int. Cl. G02B 6/38

(52) U.S. Cl. CPC G02B 6/3885; G02B 6/3825; G02B 6/3897

(57) ABSTRACT

An optical connector includes: a plurality of optical fibers each having a coating removal portion where a predetermined length of coating is removed from a tip; and a ferrule having a main body portion holding the coating removal portion of each of the optical fibers and a lens portion facing the tip in a first direction in which an optical axis of each of the optical fibers extends. The main body portion has a base portion including a plurality of fiber grooves respectively supporting the coating removal portions of the plurality of optical fibers. The plurality of fiber grooves extend along the first direction and are arranged along a second direction intersecting the first direction. The base portion has a recess portion between the fiber grooves and the lens portion in the first direction.

### TECHNICAL FIELD

The present disclosure relates to an optical connector, a ferrule, and a method for manufacturing an optical connector.

This application is based upon and claims the benefit of priority from Japanese Patent Application No. 2020-070809 filed on Apr. 10, 2020, and the entire contents of which are incorporated herein by reference.

### BACKGROUND ART

Patent Literature 1 discloses an optical connector for connecting a plurality of optical fibers to a plurality of optical fibers of a connection counterpart. The optical connector includes the plurality of optical fibers and a ferrule holding the plurality of optical fibers. The ferrule has a ferrule main body where a plurality of fiber holes respectively holding the plurality of optical fibers are formed and a lens plate disposed on the front end surface of the ferrule main body.

### CITATION LIST

### Patent Literature

Patent Literature 1: Japanese Unexamined Patent Publication No. 2019-90974

### SUMMARY OF INVENTION

An optical connector according to one embodiment of the present disclosure includes: a plurality of optical fibers each having a coating removal portion where a predetermined length of coating is removed from a tip; and a ferrule having a main body portion holding the coating removal portion of each of the optical fibers and a lens portion facing the tip in a first direction in which an optical axis of each of the optical fibers extends. The main body portion has a base portion including a plurality of fiber grooves respectively supporting the coating removal portions of the optical fibers. The fiber grooves extend along the first direction and are arranged along a second direction intersecting the first direction. The base portion has a recess portion between the fiber grooves and the lens portion in the first direction.

A ferrule according to one embodiment of the present disclosure includes: a main body portion for holding a plurality of optical fibers; and a lens portion provided at a tip side of each of the optical fibers held in the main body portion. The main body portion has a base portion including a plurality of fiber grooves for respectively supporting the optical fibers. The fiber grooves extend along a first direction and are arranged along a second direction intersecting the first direction. The base portion has a recess portion between the fiber grooves and the lens portion in the first direction.

An optical connector manufacturing method according to one embodiment of the present disclosure includes: a step of preparing a plurality of optical fibers each having a coating removal portion where a predetermined length of coating is removed from a tip and the ferrule described above; a step of forming a tip surface on the coating removal portion by laser-cutting the coating removal portion; and a step of placing each of the optical fibers in each of the fiber grooves of the ferrule.

### BRIEF DESCRIPTION OF DRAWINGS

FIG. 1 is a top view illustrating an optical connector according to an embodiment.

FIG. 2 is a top view of the optical connector in which a part of the optical connector of FIG. 1 is illustrated in a cross-sectional manner.

FIG. 3 is a cross-sectional view of the optical connector along the III-III line of FIG. 1.

FIG. 4 is an enlarged cross-sectional view of a part of a coating removal portion of FIG. 3.

FIG. 5A is a front view of a ferrule.

FIG. 5B is a rear view of the ferrule in which a part of the ferrule is illustrated in a cross-sectional manner.

FIG. 6A is a cross-sectional view illustrating an optical connector manufacturing method according to an embodiment.

FIG. 6B is a schematic cross-sectional view illustrating the step subsequent to FIG. 6A.

FIG. 7A is a schematic cross-sectional view illustrating the step subsequent to FIG. 6B.

FIG. 7B is a schematic cross-sectional view illustrating the step subsequent to FIG. 7A.

FIG. 7C is a schematic cross-sectional view illustrating the step subsequent to FIG. 7B.

### DESCRIPTION OF EMBODIMENTS

### Problems to be Solved by Present Disclosure

In the optical connector described in Patent Literature 1, in a case where, for example, the ferrule main body and the lens plate are integrally configured, the tip of the optical fiber is not exposed from the ferrule, and thus a desired tip surface cannot be formed on the optical fiber by polishing. Conceivable in this case is a method of forming a tip surface by laser-cutting the optical fiber before inserting the optical fiber into the ferrule.

However, when an optical fiber is laser-cut, the cut part of the optical fiber (that is, the tip part near the tip surface of the optical fiber) tends to become thicker than the other part of the optical fiber due to the heat of the laser. With the tip part thick as described above, it may be difficult to insert the optical fiber into a fiber hole. Meanwhile, although it is also conceivable to make the inner diameter of the fiber hole larger than the outer diameter of the tip part, in this case, the clearance between the fiber hole and the optical fiber is likely to expand and the position of the optical fiber is likely to deviate.

### Effect of Present Disclosure

According to the optical connector, the ferrule, and the method for manufacturing an optical connector according to the present disclosure, it is possible to easily mount an optical fiber while suppressing the occurrence of a positional deviation of the optical fiber.

### Description of Embodiment of Present Disclosure

First, the content of an embodiment of the present disclosure will be listed and described. An optical connector according to one embodiment of the present disclosure includes: a plurality of optical fibers each having a coating removal portion where a predetermined length of coating is removed from a tip; and a ferrule having a main body portion holding the coating removal portion of each of the optical fibers and a lens portion facing the tip in a first direction in which an optical axis of each of the optical fibers extends. The main body portion has a base portion including a plurality of fiber grooves respectively supporting the coating removal portions of the optical fibers. The fiber grooves extend along the first direction and are arranged along a second direction intersecting the first direction. The base portion has a recess portion between the fiber grooves and the lens portion in the first direction.

In this optical connector, the base portion of the ferrule has the recess portion between the fiber grooves and the lens portion. By the recess portion being provided between the fiber grooves and the lens portion, it is possible to ensure a space that allows the coating removal portion to become thick in the base portion. Accordingly, even in a case where the coating removal portion is thick, in mounting each optical fiber on the ferrule, on condition that each optical fiber is placed in each fiber groove such that the thickness of the coating removal portion is accommodated in the recess portion, each optical fiber can be easily mounted on the ferrule without being hindered by the thickness of the coating removal portion. Further, in this configuration, only the thickness of the coating removal portion can be released to the recess portion, and thus it is not necessary to increase the width of each fiber groove more than necessary in accordance with the thickness of the coating removal portion. As a result, a situation in which the clearance between each optical fiber and each fiber groove expands can be suppressed and a positional deviation of each optical fiber can be suppressed.

The coating removal portion may include a tip surface positioned at the tip. The tip surface may be inclined with respect to a plane perpendicular to the first direction. In this case, it is possible to suppress return light incidence on the optical fiber on the tip surface of the optical fiber.

The coating removal portion may include: a tip surface positioned at the tip; a first part separated from the tip surface in the first direction; and a second part positioned between the tip surface and the first part in the first direction and larger in maximum outer diameter than the first part. The fiber grooves may respectively support the first parts of the optical fibers. The recess portion may accommodate the second parts of the optical fibers. In a case where the tip surface of the coating removal portion is formed by, for example, laser cutting, the second part near the tip surface is likely to become thick. Therefore, when the optical fibers are mounted on the ferrule, the above effect is suitably achieved by placing each optical fiber in each fiber groove such that the thickened second part is accommodated in the recess portion.

A width of the recess portion in the first direction may be larger than a length of the second part in the first direction. In this case, a configuration in which the recess portion accommodates the second part of each optical fiber can be realized more reliably.

A bottom portion of the recess portion may be separated from the coating removal portion in a third direction intersecting the first direction and the second direction. In this case, it is possible to more reliably ensure a space that allows the coating removal portion to become thick in the base portion.

The main body portion may further have a lid portion facing the base portion with the optical fibers interposed therebetween in a third direction intersecting the first direction and the second direction. The lid portion may be disposed in a region facing the base portion, excluding a region facing the recess portion, and facing the fiber grooves. In this case, a positional deviation of each optical fiber can be effectively suppressed by pressing each optical fiber into each fiber groove with the lid portion. Further, in this configuration, the lid portion is not disposed in the region facing the recess portion. As a result, a situation in which the thickness of the coating removal portion in the recess portion hinders pressing each optical fiber into each fiber groove with the lid portion can be suppressed.

An adhesive for fixing the optical fibers to the main body portion may be provided in the recess portion. In this case, a positional deviation of each optical fiber can be effectively suppressed by fixing each optical fiber to the main body portion with the adhesive.

The base portion may further have a step portion on a side opposite to the recess portion with the fibers interposed therebetween in the first direction. Each of the optical fibers may further have a coating portion where the coating remains. A step surface formed between the coating portion and the coating removal portion by the coating may abut against the step portion in the first direction. In this case, the first-direction position of the tip surface of the coating removal portion in the recess portion can be adjusted by causing the step surface between the coating portion and the coating removal portion to abut against the step portion in the first direction. Accordingly, the position of the tip surface can be defined at a position that does not abut against the lens portion, and thus it is possible to suppress the occurrence of problems such as tilting of each fiber attributable to the tip surface abutting against the lens portion. As a result, the occurrence of a positional deviation of each optical fiber can be effectively suppressed.

The lens portion may include a front end surface facing a side opposite to the base portion in the first direction and a plurality of lenses provided so as to respectively correspond to the plurality of optical fibers and protruding from the front end surface. An outer surface of the ferrule may have a groove as a reference for measuring positions of the lenses and positions of the fiber grooves viewed from the first direction. The groove may continuously extend along the first direction over the main body portion from the lens portion. In this case, the deviation between the positions of the lens and the positions of the fiber grooves can be measured by measuring the positions of the lens with respect to the position of the groove at the time of viewing from one side in the first direction and the positions of the fiber grooves with respect to the position of the groove at the time of viewing from the other side in the first direction.

A ferrule according to one embodiment of the present disclosure includes: a main body portion for holding a plurality of optical fibers; and a lens portion provided at a tip side of each of the optical fibers held in the main body portion. The main body portion has a base portion including a plurality of fiber grooves for respectively supporting the optical fibers. The fiber grooves extend along a first direction and are arranged along a second direction intersecting the first direction. The base portion has a recess portion between the fiber grooves and the lens portion in the first direction.

In this ferrule, the base portion has the recess portion between the fiber grooves and the lens portion. Accordingly, even in a case where the optical fiber is thick, by the recess portion being provided between the fiber grooves and the lens portion, it is possible to ensure a space that allows the thickness in the base portion. Accordingly, in mounting each optical fiber on the ferrule, on condition that each optical fiber is placed in each fiber groove such that the thick part in each optical fiber is accommodated in the recess portion, each optical fiber can be easily mounted on the ferrule without being hindered by the thickness. Further, in this configuration, only the thickness can be released to the recess portion, and thus it is not necessary to increase the width of each fiber groove more than necessary in accordance with the thickness of each optical fiber. As a result, a situation in which the clearance between each optical fiber and each fiber groove expands can be suppressed and a positional deviation of each optical fiber can be suppressed.

An optical connector manufacturing method according to one embodiment of the present disclosure includes: a step of preparing a plurality of optical fibers each having a coating removal portion where a predetermined length of coating is removed from a tip and the ferrule described above; a step of forming a tip surface on the coating removal portion by laser-cutting the coating removal portion; and a step of placing each of the optical fibers in each of the fiber grooves of the ferrule described above.

In this optical connector manufacturing method, each optical fiber is placed in each fiber groove after forming the tip surface of the coating removal portion of each optical fiber by laser cutting. When the tip surface is formed on the coating removal portion by laser cutting, thickening may occur near the tip surface of the coating removal portion. Here, the base portion of the ferrule has the recess portion between the fiber grooves and the lens portion. By the recess portion being provided between the plurality of fiber grooves and the lens portion, it is possible to ensure a space that allows the coating removal portion to become thick in the base portion. Accordingly, even in a case where the coating removal portion is thick, in mounting each optical fiber on the ferrule, by each optical fiber being placed in each fiber groove such that the thickness of the coating removal portion is accommodated in the recess portion, each optical fiber can be easily mounted on the ferrule without being hindered by the thickness of the coating removal portion. Further, in this manufacturing method, only the thickness of the coating removal portion can be released to the recess portion, and thus it is not necessary to increase the width of each fiber groove more than necessary in accordance with the thickness of the coating removal portion. As a result, a situation in which the clearance between each optical fiber and each fiber groove expands can be suppressed and a positional deviation of each optical fiber can be suppressed.

In the step of forming the tip surface, the tip surface may be inclined with respect to a plane perpendicular to the first direction. In this case, it is possible to suppress return light incidence on the optical fiber on the tip surface of the optical fiber.

The optical connector manufacturing method described above may further include: a step of injecting an adhesive for fixing the optical fibers to the main body portion into the recess portion after the step of placing each of the optical fibers; and a step of disposing a lid portion so as to face the base portion with the optical fibers interposed therebetween in a third direction intersecting the first direction and the second direction after the step of injecting the adhesive into the recess portion. In the step of disposing the lid portion, the lid portion may be disposed in a region excluding a region facing the recess portion. By disposing the lid portion on the plurality of fiber grooves after injecting the adhesive into the recess portion in this manner, the adhesive can be spread not only in the recess portion but also to the region between the lid portion and the plurality of optical fibers. As a result, a positional deviation of each optical fiber with respect to the ferrule can be effectively suppressed. Further, a positional deviation of each optical fiber can be effectively suppressed by pressing each optical fiber into each fiber groove with the lid portion. Further, since the lid portion is not disposed in the region facing the recess portion, a situation in which the thickness of the coating removal portion hinders pressing each optical fiber into each fiber groove with the lid portion can be suppressed.

### Details of Embodiment of Present Disclosure

Hereinafter, one embodiment of the present disclosure will be described in detail with reference to the drawings. In the following description, the same reference numerals will be used for the same or functionally identical elements with redundant description omitted.

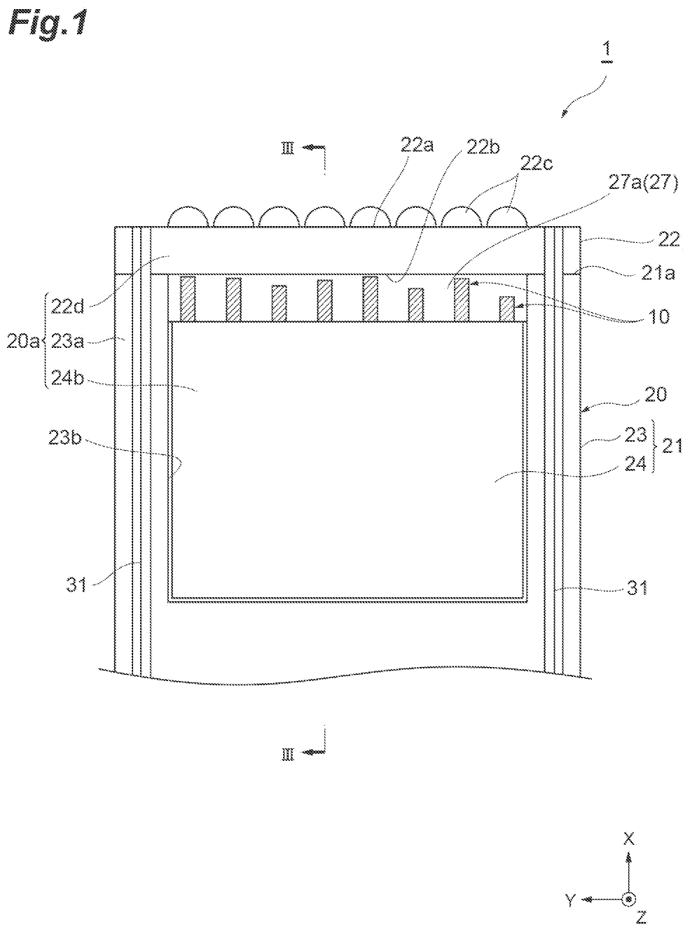

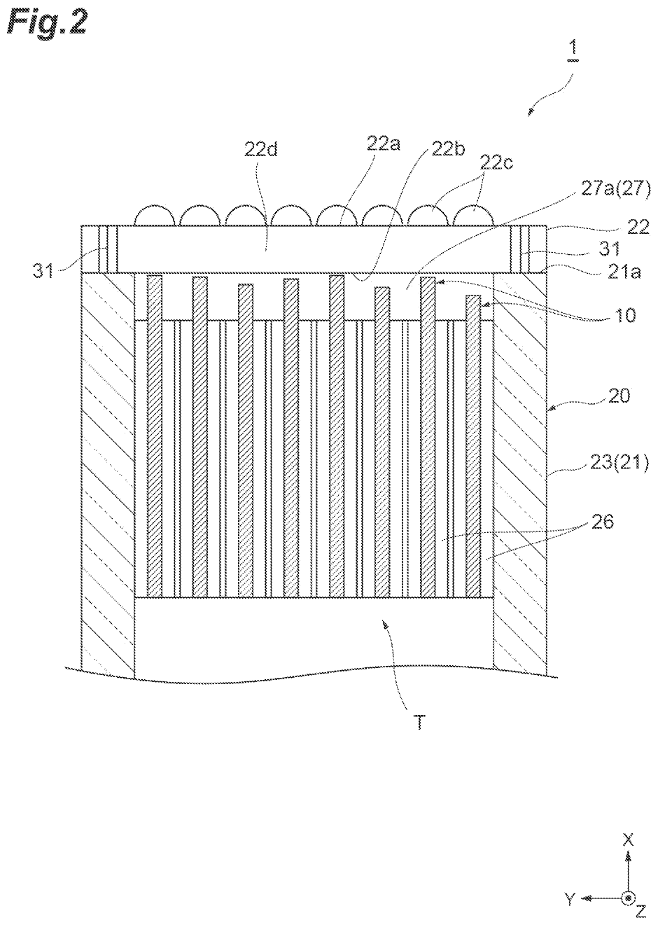

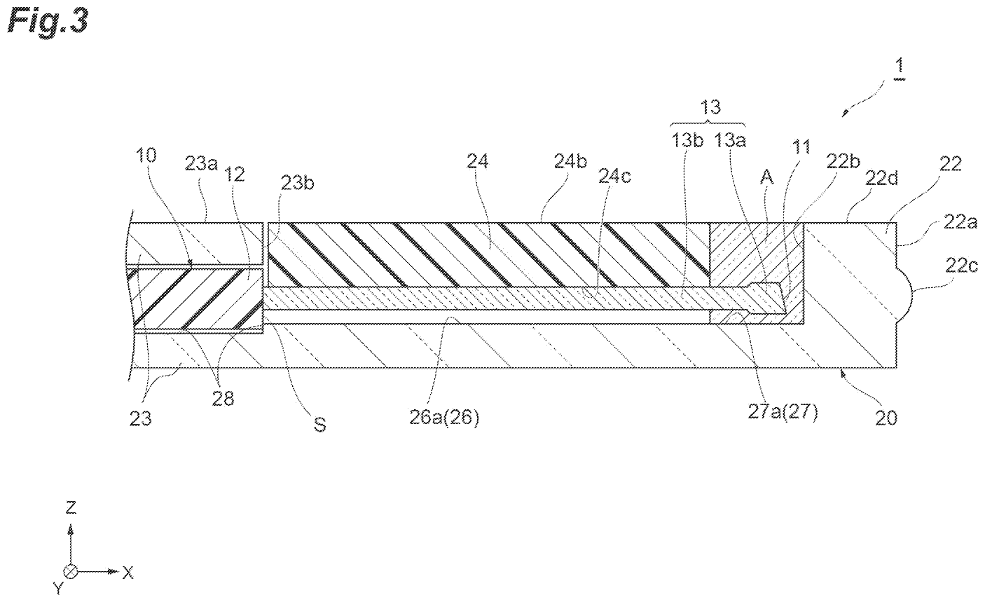

FIG. 1 is a top view illustrating an optical connector 1 according to the present embodiment. FIG. 2 is a top view of the optical connector 1 in which a part of the optical connector 1 of FIG. 1 is illustrated in a cross-sectional manner. FIG. 3 is a cross-sectional view of the optical connector 1 along the III-III line of FIG. 1. An XYZ orthogonal coordinate system for ease of understanding is illustrated in each of the drawings. An adhesive A is not illustrated in FIGS. 1 and 2. In the present embodiment, the X direction is a first direction and the direction of connection between the optical connector 1 and the optical connector of a connection counterpart, the Y direction is a second direction and is orthogonal to the X direction, and the Z direction is a third direction and is orthogonal to the X direction and the Y direction. The following description may be given with the directions of “front” and “rear” determined. In the X direction, the optical connector side of the connection counterpart with respect to the optical connector 1 is the front and the opposite side is the rear.

As illustrated in FIGS. 1, 2, and 3, the optical connector 1 includes a tape fiber T including a plurality of optical fibers 10 and a ferrule 20 where the front end portion of the tape fiber T is inserted. The ferrule 20 has a main body portion 21 holding each optical fiber 10 of the tape fiber T and a lens portion 22 provided on a front end surface 21a of the main body portion 21.

The main body portion 21 has a substantially rectangular parallelepiped appearance. The main body portion 21 has a base portion 23 and a lid portion 24 facing each other in the Z direction. The base portion 23 is a part supporting each optical fiber 10. The base portion 23 is configured integrally with the lens portion 22. The base portion 23 is configured by, for example, a light-transmitting resin such as polyetherimide (PEI), polycarbonate (PC), polymethylmethacrylate (PMMA), and polyethersulfone (PES). The base portion 23 includes a plurality of fiber grooves 26 respectively supporting the optical fibers 10, a recess portion 27 formed in front of the fiber grooves 26, and a step portion 28 formed behind the fiber grooves 26.

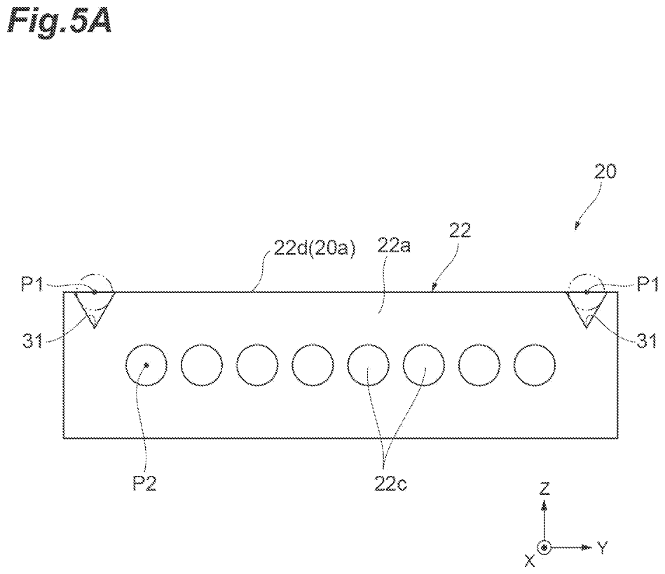

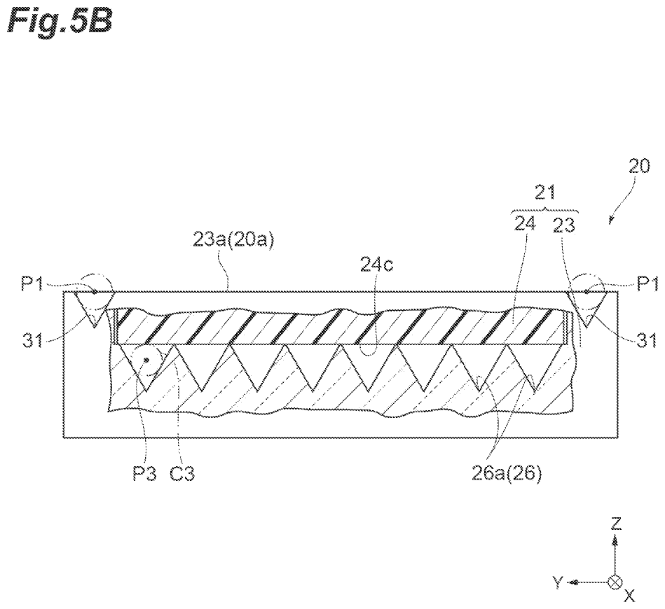

As illustrated in FIG. 2, the plurality of fiber grooves 26 extend along the X direction and are arranged along the Y direction. In FIG. 2, the base portion 23 of the main body portion 21 is illustrated as an XY cross section, and each optical fiber 10 supported by each fiber groove 26 is illustrated in a visible state. The fiber grooves 26 are, for example, arranged in parallel and at equal intervals along the Y direction. The YZ cross section of each fiber groove 26 has, for example, a V shape opening toward the lid portion 24 in the Z direction (see FIG. 5B to be described later). The fiber grooves 26 respectively support the optical fibers 10. When viewed from the Z direction, bottom portions 26a of the fiber grooves 26 respectively coincide with, for example, the centers of the optical fibers 10.

As illustrated in FIGS. 2 and 3, the recess portion 27 is recessed in the Z direction between, for example, each fiber groove 26 and the lens portion 22 in the X direction. The recess portion 27 is, for example, a linear groove extending along the Y direction. The recess portion 27 extends along the Y direction so as to, for example, connect the region between each fiber groove 26 and the lens portion 22 in the X direction. As illustrated in FIG. 3, the XZ cross section of the recess portion 27 has, for example, a rectangular shape. A bottom surface 27a of the recess portion 27 is, for example, a flat surface along the XY plane. The YZ cross section of the recess portion 27 also has, for example, a rectangular shape as in the case of the XZ cross section of the recess portion 27.

The depth of the bottom surface 27a of the recess portion 27 is, for example, the same as the depth of the bottom portion 26a of the fiber groove 26. In other words, the position of the bottom surface 27a in the Z direction coincides with the position of the bottom portion 26a in the Z direction. The depth of the bottom surface 27a of the recess portion 27 may be deeper than the depth of the bottom portion 26a of the fiber groove 26. In other words, the bottom surface 27a may be positioned below the bottom portion 26a. Here, “below” means the direction from the top portion of the fiber groove 26 toward the bottom portion 26a in the Z direction. The adhesive A for fixing each optical fiber 10 to the base portion 23 is injected and embedded in the recess portion 27. The adhesive A is configured by, for example, a light-transmitting material. The adhesive A may enter the gap between the lid portion 24 and the base portion 23. For example, the adhesive A may enter the inside of each fiber groove 26 (that is, the gap between each optical fiber 10 and each fiber groove 26).

The lid portion 24 is, for example, a plate-shaped member extending along the XY plane. The lid portion 24 is configured separately from the base portion 23. The lid portion 24 is configured by, for example, a resin such as polyphenylene sulfide (PPS) or glass. The lid portion 24 may be configured by the same light-transmitting resin as the base portion 23 and the lens portion 22 such as polyetherimide (PEI), polycarbonate (PC), polymethylmethacrylate (PMMA), and polyethersulfone (PES). The lid portion 24 is disposed in the region that faces the base portion 23 in the Z direction, excludes the region facing the recess portion 27 in the Z direction, and faces each fiber groove 26 in the Z direction. In the present embodiment, as illustrated in FIGS. 1 and 3, an opening 23b is formed at the part of an upper surface 23a of the base portion 23 that faces the fiber grooves 26 and the recess portion 27. Further, the lid portion 24 is disposed only in the region facing the fiber grooves 26 in the opening 23b. In other words, the lid portion 24 is disposed in the region facing the fiber grooves 26 in the opening 23b and is not disposed in the region facing the recess portion 27 in the opening 23b.

As illustrated in FIG. 3, the lid portion 24 includes an upper surface 24b and a lower surface 24c facing each other in the Z direction. The upper surface 24b and the lower surface 24c are, for example, flat surfaces extending along the XY plane. In one example, the upper surface 24b and the lower surface 24c are disposed parallel to each other along the Z direction. The upper surface 24b faces the side opposite to the base portion 23 in the Z direction. The lower surface 24c faces the base portion 23 (specifically, the fiber grooves 26) in the Z direction. The upper surface 24b of the lid portion 24 is flush with, for example, the upper surface 23a of the base portion 23. The upper surface 24b of the lid portion 24 and the upper surface 23a of the base portion 23 configure an upper surface 20a of the ferrule 20 (see FIG. 1). The upper surface 20a configures a part of the outer surface of the ferrule 20. The lower surface 24c is in contact with each optical fiber 10. The lower surface 24c presses each optical fiber 10 to each fiber groove 26 in the Z direction. As illustrated in FIG. 3, it is preferable that the lower surface 24c is configured to be in contact with a coating removal portion 13 of the optical fiber 10 and not to be in contact with a coating portion 12 of the optical fiber 10. As a result, the coating removal portion 13 of each optical fiber 10 can be more reliably brought into contact with each fiber groove 26. As a result, each optical fiber 10 can be positioned more reliably.

The lens portion 22 has, for example, a plate shape extending along the XZ plane. The lens portion 22 is configured integrally with the base portion 23. Accordingly, the lens portion 22 is configured by the same material as the base portion 23. As illustrated in FIGS. 1, 2, and 3, the lens portion 22 includes a front end surface 22a and a rear end surface 22b facing each other in the X direction, an upper surface 22d connecting the front end surface 22a and the rear end surface 22b in the X direction, and a plurality of lenses 22c provided on the front end surface 22a. The front end surface 22a and the rear end surface 22b are, for example, flat surfaces extending along the XY plane. In one example, the front end surface 22a and the rear end surface 22b are disposed parallel to each other along the X direction. The upper surface 22d is, for example, a flat surface extending along the XY plane. The upper surface 22d is disposed side by side with the upper surface 23a of the base portion 23 and the upper surface 24b of the lid portion 24 in the X direction. The upper surface 22d is, for example, disposed at the same position as the upper surfaces 23a and 24b in the Z direction and extends in parallel with the upper surfaces 23a and 24b. The upper surface 22d configures the upper surface 20a of the ferrule 20 together with the upper surfaces 23a and 24b. The front end surface 22a may be inclined with respect to the rear end surface 22b.

Each lens 22c is a convex lens protruding forward from the front end surface 22a. The lenses 22c are disposed side by side along the Y direction so as to respectively correspond to the positions of the optical fibers 10 (that is, the positions of the fiber grooves 26). Each lens 22c faces each optical fiber 10 in the X direction. Each lens 22c is optically coupled to each optical fiber 10. When viewed from the X direction, the optical axis of each lens 22c coincides with, for example, the optical axis of each optical fiber 10. The light emitted from each optical fiber 10 is converted into parallel light (that is, collimated light) by each lens 22c and then incident on the optical connector of the connection counterpart. The optical axis of each lens 22c and the optical axis of each optical fiber 10 may be deviated from each other.

Each optical fiber 10 is supported by each fiber groove 26. As illustrated in FIG. 2, each optical fiber 10 is disposed so as to correspond to each fiber groove 26. In other words, each optical fiber 10 extends along the X direction and is arranged along the Y direction. The optical axis direction of each optical fiber 10 coincides with the X direction. As illustrated in FIG. 3, each optical fiber 10 includes a tip surface 11, the coating removal portion 13 including the tip surface 11, and the coating portion 12 disposed on the side opposite to the tip surface 11 with the coating removal portion 13 interposed therebetween in the X direction.

The tip surface 11 is positioned at the tip of each optical fiber 10 closer to the lens portion 22 in the X direction. The tip surface 11 is, for example, slightly inclined (for example, approximately 8°) with respect to the YZ plane perpendicular to the X direction. The core of each optical fiber 10 is exposed from the tip surface 11. The coating removal portion 13 is the part of each optical fiber 10 where a predetermined length of coating is removed from the tip surface 11. In the coating removal portion 13, the cladding of each optical fiber 10 is exposed. The coating portion 12 is a coating-remaining part. The diameter of the coating portion 12 is larger than the diameter of the coating removal portion 13 and is, for example, 250 μm.

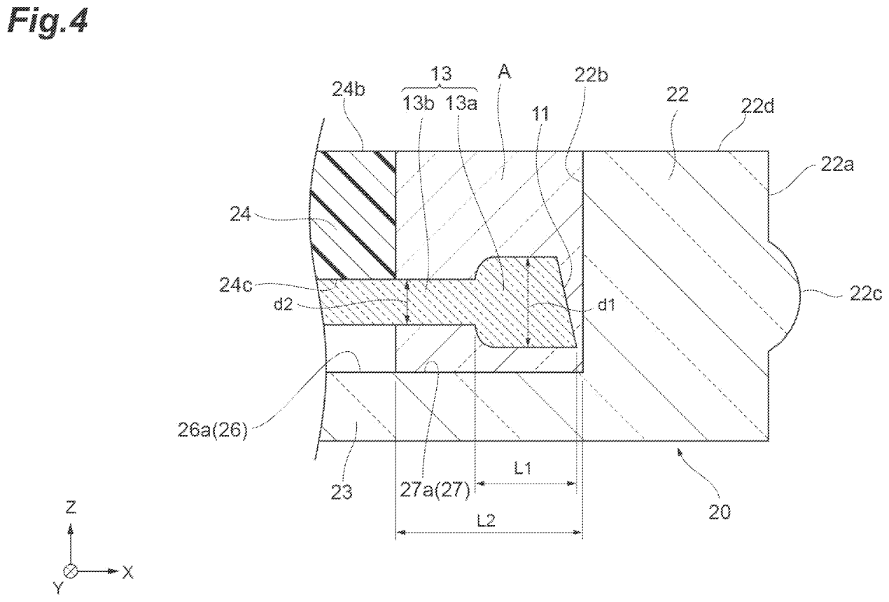

The coating removal portion 13 has a tip part 13a including the tip surface 11 and an intermediate part 13b positioned between the tip part 13a and the coating portion 12 in the X direction. The tip part 13a is thicker than the intermediate part 13b. In other words, a maximum outer diameter d1 of the tip part 13a is larger than a maximum outer diameter d2 of the intermediate part 13b (see FIG. 4 to be described later). The maximum outer diameter d1 of the tip part 13a is, for example, 0.2 μm to 10 μm larger than the maximum outer diameter d2 of the intermediate part 13b. The tip surface 11 is formed by laser cutting as will be described later. At the time of this laser cutting, the tip part 13a including the tip surface 11 becomes thick by the heat of the laser being applied to the tip part 13a. As a result, the tip part 13a becomes thicker than the intermediate part 13b.

As illustrated in FIG. 3, the tip part 13a of the coating removal portion 13 is disposed in the recess portion 27. The intermediate part 13b of the coating removal portion 13 is disposed on the fiber groove 26. The coating portion 12 is disposed on the step portion 28. The step portion 28 is disposed at a position that does not interfere with the coating portion 12 in a state where the intermediate part 13b is disposed on the fiber groove 26. In the example illustrated in FIG. 3, the step portion 28 is disposed at a position separated from the coating portion 12 in the Z direction. The depth of the step portion 28 in the Z direction may be deeper than the depth of the bottom portion 26a of the fiber groove 26 such that the step portion 28 does not interfere with the coating portion 12. The step portion 28 may be disposed at a position in contact with the coating portion 12 in the Z direction.

A coating thickness-attributable step surface S is formed between the coating removal portion 13 and the coating portion 12 due to the thickness of the coating. The step surface S faces the step portion 28 in the X direction. In the example illustrated in FIG. 3, the step surface S abuts against the step portion 28 in the X direction. When each optical fiber 10 is placed on the base portion 23, the position of the tip surface 11 of each optical fiber 10 with respect to the base portion 23 can be defined by the step surface S between the coating removal portion 13 and the coating portion 12 abutting against the step portion 28 in the X direction. The intermediate part 13b of the coating removal portion 13 is supported by the fiber groove 26. The intermediate part 13b is, for example, in contact with each of the pair of surfaces configuring the fiber groove 26 and is separated from the bottom portion 26a of the fiber groove 26 in the Z direction. In other words, in the YZ cross section of the fiber groove 26 illustrated in FIG. 5B, the intermediate part 13b indicated by an inscribed circle C3 is in two-point contact with the pair of surfaces configuring the fiber groove 26. Further, in a state where the lid portion 24 is disposed on the intermediate part 13b, in the YZ cross section of the fiber groove 26 illustrated in FIG. 5B, the intermediate part 13b indicated by the inscribed circle C3 is in three-point contact with the pair of surfaces and the lid portion 24. The intermediate part 13b is held by the pair of surfaces and the lid portion 24. The inscribed circle C3 illustrated in FIG. 5B is a virtual circle inscribed in the pair of surfaces configuring the fiber groove 26 and coincides with the outline of the intermediate part 13b. Accordingly, in FIG. 5B, the position of the intermediate part 13b can be indicated by the inscribed circle C3.

FIG. 4 is an enlarged cross-sectional view of the vicinity of the tip part 13a of FIG. 3. As illustrated in FIG. 4, the tip part 13a is accommodated in the recess portion 27. The tip part 13a being accommodated in the recess portion 27 means a state where at least a part of the tip part 13a is disposed in the recess portion 27. The shape of the recess portion 27 is set in view of the thickness of the tip part 13a. The bottom surface 27a of the recess portion 27 is disposed at a position that does not interfere with the tip part 13a in a state where the intermediate part 13b is placed on the fiber groove 26. As illustrated in FIG. 4, the bottom surface 27a of the recess portion 27 is, for example, disposed at a position separated from the tip part 13a in the Z direction.

The bottom surface 27a of the recess portion 27 may be disposed at a position in contact with the tip part 13a. A width L2 of the recess portion 27 in the X direction is set to be larger than a length L1 of the tip part 13a. The length L1 of the tip part 13a is, for example, 200 μm or more and 300 μm or less. The width L2 of the recess portion 27 is, for example, 400 μm or more and 500 μm or less.

In the recess portion 27, the tip surface 11 of each optical fiber 10 is, for example, separated from the rear end surface 22b of the lens portion 22 in the X direction. The position of the tip surface 11 in the recess portion 27 can be adjusted by adjusting the length of the coating removal portion 13 in the X direction, that is, the distance between the step surface S and the tip surface 11 in the X direction with the step surface S between the coating portion 12 and the coating removal portion 13 abutting against the step portion 28. The length of the coating removal portion 13 in the X direction can be accurately adjusted by adjusting the cutting position at the time of the laser cutting. By adjusting the length of the coating removal portion 13 in the X direction, the position of the tip surface 11 in the recess portion 27 can be set to be separated from the rear end surface 22b of the lens portion 22. The tip surface 11 does not necessarily have to be separated from the rear end surface 22b and may be in contact with the rear end surface 22b.

Referring back to FIG. 1, the upper surface 20a of the ferrule 20 includes a pair of grooves 31 serving as references for measuring the positions of the lens 22c and the positions of the fiber grooves 26 that are viewed from the X direction. The grooves 31 extend along the X direction in the upper surface 20a and are disposed side by side along the Y direction. The YZ cross section of each groove 31 has, for example, a V shape opening upward (that is, on the side opposite to the base portion 23 with respect to the lid portion 24 in the Z direction) in the Z direction (see FIGS. 5A and 5B). The tip part of this V shape (that is, the bottom portion of the V groove) may be rounded.

Each groove 31 extends over the X direction so as to connect both ends of the upper surface 20a in the X direction. In other words, each groove 31 continuously extends along the X direction over the rear end of the upper surface 23a of the base portion 23 from the front end of the upper surface 22d of the lens portion 22 in the upper surface 20a. The grooves 31 are, for example, disposed side by side in both end portions of the upper surface 20a in the Y direction. Each groove 31 is, for example, disposed at a position where the fiber grooves 26 are interposed in the Y direction when viewed from the Z direction.

FIG. 5A is a front view illustrating the ferrule 20 that is viewed from the front side in the X direction. FIG. 5B is a rear view illustrating the ferrule 20 that is viewed from the rear side in the X direction. FIG. 5B illustrates the ferrule 20 in which each optical fiber 10 is yet to be placed in each fiber groove 26, in which the base portion 23 and the lid portion 24 in the vicinity of each fiber groove 26 are illustrated as YZ cross sections. As described above, each groove 31 extends over the X direction in the upper surface 20a. Accordingly, as illustrated in FIG. 5A, when the ferrule 20 is viewed from the front side in the X direction, the front end of each groove 31 can be visually recognized in the upper surface 22d of the lens portion 22. Meanwhile, as illustrated in FIG. 5B, when the ferrule 20 is viewed from the rear side in the X direction, the rear end of each groove 31 can be visually recognized in the upper surface 23a of the base portion 23. Accordingly, the position of the rear end of each fiber groove 26 and the position of each lens 22c can be measured with reference to the position of each groove 31 viewed from the X direction.

In measuring the positions of lens 22c with reference to the position of each groove 31, the front end surface 22a of the lens portion 22 is imaged from the front side. In the captured image, the line connecting a center position P1 of the inscribed circle inscribed in the pair of surfaces configuring one groove 31 and the center position P1 of the inscribed circle inscribed in the pair of surfaces configuring the other groove 31 is defined as the Y axis, and the line orthogonal to the Y axis and starting from the midpoint of the line connecting the two center positions P1 and P1 is defined as the Z axis (see FIG. 5A). Then, in the YZ plane indicated by the YZ axes, a center position (that is, an optical axis position) P2 of the lens 22c with respect to the center position P1 of each groove 31 is measured.

The main body portion 21 is imaged from the rear side in measuring the position of the rear end of each fiber groove 26 with reference to the position of each groove 31. In the captured image, as in the above, the line connecting the center position P1 of one groove 31 and the center position P1 of the other groove 31 is defined as the Y axis, and the line orthogonal to the Y axis and starting from the midpoint of the line connecting the two center positions P1 and P1 is defined as the Z axis (see FIG. 5B). Then, in the YZ plane indicated by the YZ axes, a center position P3 of the inscribed circle C3 inscribed in the pair of surfaces configuring the fiber groove 26 is measured with respect to the center position P1 of each groove 31. In this manner, by comparing the center position P2 of each lens 22c with the center position P3 of each fiber groove 26 with reference to the center position P1 of each groove 31, the amount of eccentricity between the center position P2 of each lens 22c and the center position P3 of each fiber groove 26 can be obtained.

In the present embodiment, each fiber groove 26 can be visually recognized from the rear side of the main body portion 21 since the base portion 23 is configured by a light-transmitting resin (that is, a transparent resin). Accordingly, the center position P3 of each fiber groove 26 can be measured in an image in which the main body portion 21 is imaged from the rear side. On the other hand, in a case where the main body portion 21 is configured by an opaque resin, the center position P3 of each fiber groove 26 can be measured by, for example, cutting the main body portion 21 in the YZ cross section at the position of the tip of each fiber groove 26. Each groove 31 does not have to connect both ends of the upper surface 20a in the X direction. In other words, each groove 31 may extend in the X direction to a position on the upper surface 20a that does not reach both ends in the X direction. Even in such a case, regardless of whether the base portion 23 is configured by a transparent resin or an opaque resin, the center position P1 of each groove 31 can be measured in the same manner as the measurement of the center position P3 of each fiber groove 26.

In measuring the center position of the front end of each fiber groove 26 with reference to the center position P1 of each groove 31, the center position of the front end of each fiber groove 26 can be measured with respect to the center position P1 of each groove 31 by measuring the height profiles of each fiber groove 26 and each groove 31 from the upper surface 20a of the ferrule 20 using, for example, a contact meter or a laser displacement meter. Accordingly, by comparing the center position P2 of each lens 22c with the center position of the front end of each fiber groove 26 with reference to the center position P1 of each groove 31, the amount of eccentricity between the center position P2 of each lens 22c and the center position of the front end of each fiber groove 26 can be obtained.

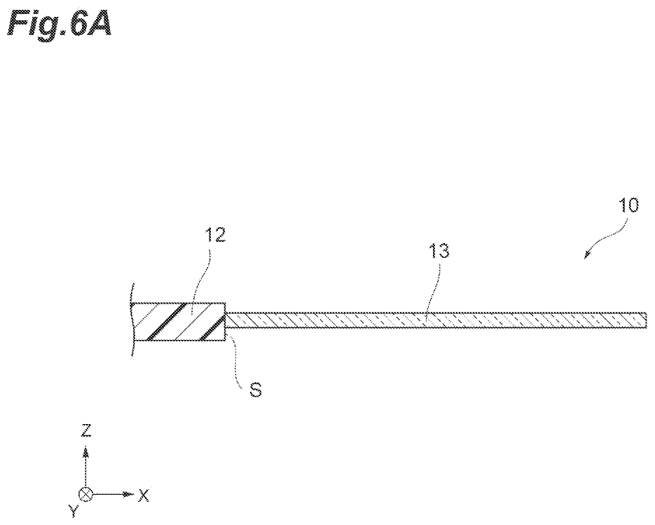

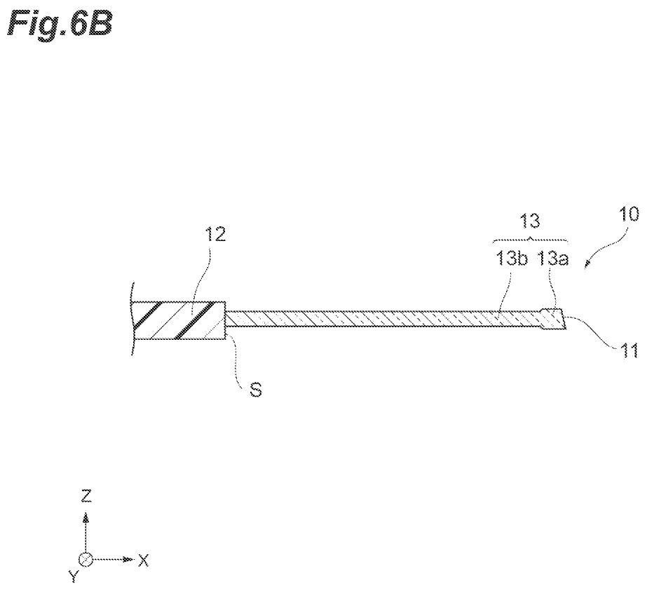

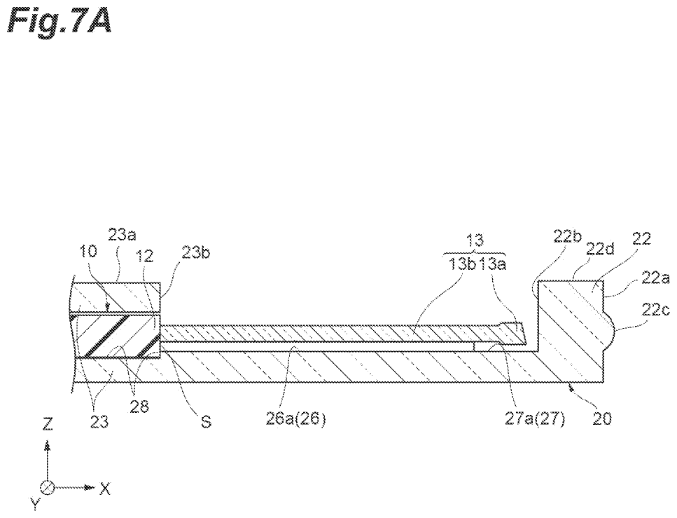

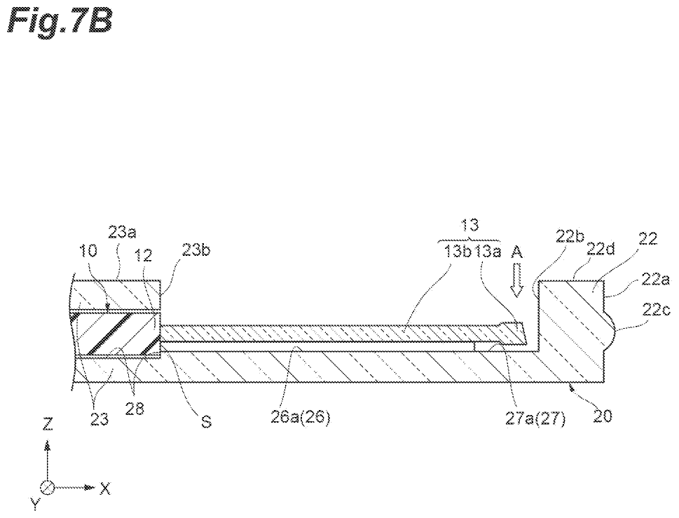

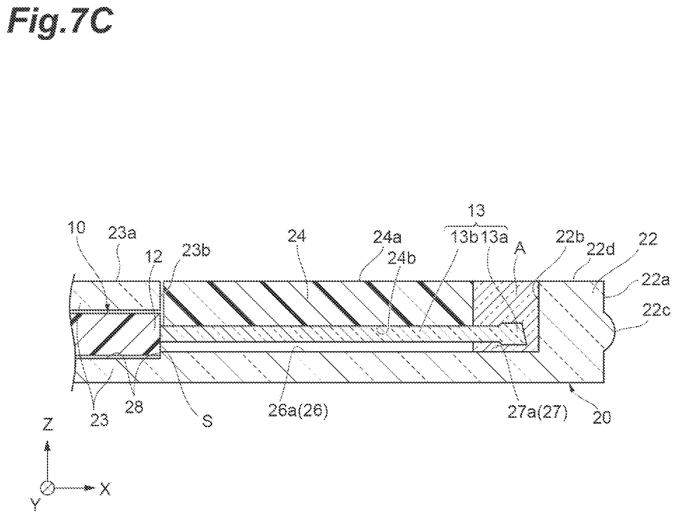

A method for manufacturing the optical connector 1 described above will be described below with reference to FIGS. 6A, 6B, 7A, 7B, and 7C. FIG. 6A is a cross-sectional view illustrating the method for manufacturing the optical connector 1 according to the present embodiment. FIG. 6B is a cross-sectional view illustrating the step subsequent to FIG. 6A. FIG. 7A is a cross-sectional view illustrating the step subsequent to FIG. 6B. FIG. 7B is a cross-sectional view illustrating the step subsequent to FIG. 7A. FIG. 7C is a cross-sectional view illustrating the step subsequent to FIG. 7B.

First, as illustrated in FIG. 6A, each optical fiber 10 having the coating portion 12 and the coating removal portion 13 is prepared. Further, the ferrule 20 having the base portion 23 integrated with the lens portion 22 and the lid portion 24 separate from the base portion 23 is prepared. The coating removal portion 13 can be formed by, for example, a method by which a coating is peeled off using a blade of metal or the like. Alternatively, the coating removal portion 13 may be formed by a chemical method such as decomposing and removing a coating with hot concentrated sulfuric acid.

Next, as illustrated in FIG. 6B, the tip surface 11 is formed by laser-cutting the coating removal portion 13. Here, the coating removal portion 13 is laser-cut such that the tip surface 11 is slightly inclined (for example, approximately 8°) with respect to the YZ plane. At this time, as described above, the tip part 13a becomes thick by the heat of the laser being applied to the tip part 13a including the tip surface 11. As a result, the tip part 13a becomes thicker than the intermediate part 13b of the coating removal portion 13.

Next, as illustrated in FIG. 7A, each optical fiber 10 is disposed on the base portion 23 of the ferrule 20. Here, the coating portion 12 is disposed on the step portion 28, the intermediate part 13b of the coating removal portion 13 is disposed on the fiber groove 26, and the tip part 13a of the coating removal portion 13 is disposed in the recess portion 27. Then, the step surface S between the coating portion 12 and the coating removal portion 13 is caused to abut against the step portion 28 of the base portion 23 in the X direction. As a result, the X-direction position of the tip surface 11 in the recess portion 27 is defined. In the present embodiment, the position of the tip surface 11 in the X direction is set to a position separated in the X direction from the rear end surface 22b of the lens 22c.

Next, as illustrated in FIG. 7B, the adhesive A is injected into the recess portion 27. As a result, the inside of the recess portion 27 is embedded by the adhesive A. Next, as illustrated in FIG. 7C, the lid portion 24 of the ferrule 20 is disposed on each optical fiber 10. Specifically, the lid portion 24 is disposed only in the region facing the fiber groove 26 via each optical fiber 10 in the opening 23b of the base portion 23. At this time, the adhesive A injected in the recess portion 27 also spreads to the gap between the lid portion 24 and each optical fiber 10. By curing the adhesive A in this state, each optical fiber 10 is fixed to the base portion 23 and the lid portion 24. The optical connector 1 is obtained through the above process.

In the optical connector 1, the ferrule 20, and the method for manufacturing the optical connector 1 according to the present embodiment described above, the base portion 23 of the ferrule 20 includes the recess portion 27 between the fiber grooves 26 and the lens portion 22. By the recess portion 27 being provided between the fiber grooves 26 and the lens portion 22 as described above, it is possible to ensure a space that allows the tip part 13a to become thick in the base portion 23. Accordingly, in mounting each optical fiber 10 on the ferrule 20, on condition that the intermediate part 13b is placed in each fiber groove 26 such that the thickened tip part 13a is accommodated in the recess portion 27, each optical fiber 10 can be easily mounted on the ferrule 20 without being hindered by the thickness of the tip part 13a. Further, in the present embodiment, only the thickness of the tip part 13a can be released to the recess portion 27, and thus it is not necessary to increase the width of each fiber groove 26 more than necessary in accordance with the thickness of the tip part 13a. As a result, a situation in which the clearance between each optical fiber 10 and each fiber groove 26 expands can be suppressed and a positional deviation of each optical fiber 10 can be suppressed.

In the present embodiment, the tip surface 11 is inclined with respect to a plane perpendicular to the X direction. As a result, it is possible to suppress return light incidence on each optical fiber 10 on the tip surface 11 of each optical fiber 10.

In the present embodiment, each fiber groove 26 supports the intermediate part 13b of each optical fiber 10. The recess portion 27 accommodates the tip part 13a of each optical fiber 10. When the tip surface 11 of the coating removal portion 13 is formed by laser cutting, the tip part 13a near the tip surface 11 is likely to become thick. Therefore, when optical fibers 10 are mounted on the ferrule 20, the above effect is suitably achieved by placing each optical fiber 10 in each fiber groove 26 such that the thickened tip part 13a is accommodated in the recess portion 27.

In the present embodiment, the width L2 of the recess portion 27 in the X direction is larger than the length L1 of the tip part 13a in the X direction. As a result, a configuration in which the recess portion 27 accommodates the tip part 13a of each optical fiber 10 can be realized more reliably.

In the present embodiment, the recess portion 27 is a linear groove extending along the Y direction so as to connect the region between each fiber groove 26 and the lens portion 22 in the X direction. As a result, the shape of the recess portion 27 is simplified as compared with a case where the recess portion 27 is formed for each fiber groove 26, and thus the ferrule 20 can be manufactured with ease.

In the present embodiment, the bottom surface 27a of the recess portion 27 is separated from the tip part 13a in the Z direction. As a result, it is possible to more reliably ensure the space that allows the tip part 13a to become thick in the base portion 23.

In the present embodiment, the lid portion 24 is disposed in the region that faces the base portion 23, excludes the region facing the recess portion 27, and faces each fiber groove 26. In this configuration, a positional deviation of each optical fiber 10 can be effectively suppressed by pressing each optical fiber 10 into each fiber groove 26 with the lid portion 24. Further, since the lid portion 24 is not disposed in the region facing the recess portion 27, a situation in which the thickness of the tip part 13a in the recess portion 27 hinders pressing each optical fiber 10 into each fiber groove 26 with the lid portion 24 can be suppressed.

In the present embodiment, the adhesive A for fixing the optical fibers 10 to the base portion 23 is provided in the recess portion 27. A positional deviation of each optical fiber 10 can be effectively suppressed by fixing each optical fiber 10 to the base portion 23 with the adhesive A.

In the present embodiment, the step surface S formed between the coating portion 12 and the coating removal portion 13 abuts against the step portion 28 in the X direction. By causing the step surface S between the coating portion 12 and the coating removal portion 13 to abut against the step portion 28 in the X direction, the position of the tip surface 11 in the recess portion 27 can be adjusted. As a result, the position of the tip surface 11 can be defined at a position that does not abut against the lens portion 22, and thus it is possible to suppress the occurrence of problems such as tilting, warping, and breakage of each optical fiber 10 attributable to the tip surface 11 abutting against the lens portion 22. As a result, the occurrence of a positional deviation of each optical fiber 10 can be effectively suppressed.

In the present embodiment, the upper surface 20a of the ferrule 20 includes the pair of grooves 31 serving as references for measuring the center position P2 of each lens 22c and the center position P3 of each fiber groove 26 that are viewed from the X direction. As a result, the amount of eccentricity between the center position P2 of the lens 22c and the center position P3 of the fiber groove 26 can be measured by measuring the center position P2 of each lens 22c with respect to the center position P1 of each groove 31 at the time of viewing from the front side and the center position P3 of each fiber groove 26 with respect to the center position P1 of each groove 31 at the time of viewing from the rear side.

In the present embodiment, the adhesive A is injected into the recess portion 27, and then the lid portion 24 is disposed so as to face the base portion 23 with each optical fiber 10 interposed therebetween. By disposing the lid portion 24 on the plurality of fiber grooves 26 after injecting the adhesive A into the recess portion 27 in this manner, the adhesive A can be spread not only in the recess portion 27 but also to the region between the lid portion 24 and the plurality of optical fibers 10. As a result, a positional deviation of each optical fiber 10 with respect to the ferrule 20 can be effectively suppressed.

The optical connector, the ferrule, and the optical connector manufacturing method of the present disclosure are not limited to the embodiment described above, and various other modifications are possible. For example, in the embodiment described above, the configuration of the ferrule can be changed as appropriate. For example, in the embodiment described above, the recess portion is provided so as to extend along the Y direction such that connection is provided between each fiber groove and the lens portion. However, the recess portion may also be provided for each fiber groove. The XZ cross section and the YZ cross section of the recess portion are not limited to a rectangular shape and may have another shape such as a semicircular shape and a trapezoidal shape. The YZ cross section of each fiber groove is not limited to a V shape and may have another shape such as a semicircular shape and a rectangular shape. The YZ cross section of each groove serving as a reference for measuring the position of each lens and the position of each fiber groove is not limited to a V shape and may have another shape such as a semicircular shape and a rectangular shape.

The ferrule may be formed with a pair of guide pin insertion holes into which a pair of guide pins are respectively inserted. In this case, the pair of guide pin insertion holes may extend rearward along the X direction from the position where each lens on the front end surface of the lens portion is sandwiched in the Y direction. With end portions of the pair of guide pins respectively inserted in the pair of guide pin insertion holes, the ferrule and a connection counterpart ferrule can be aligned by the other end portions of the pair of guide pins being respectively inserted into a pair of guide pin insertion holes formed in the connection counterpart ferrule.

### REFERENCE SIGNS LIST

1: optical connector, 10: optical fiber, 11: tip surface, 12: coating portion, 13: coating removal portion, 13a: tip part, 13b: intermediate part, 20: ferrule, 20a: upper surface, 21: main body portion, 21a: front end surface, 22: lens portion, 22a: front end surface, 22b: rear end surface, 22c: lens, 22d: upper surface, 23: base portion, 23a: upper surface, 23b: opening, 24: lid portion, 24b: upper surface, 24c: lower surface, 26: fiber groove, 26a: bottom portion, 27: recess portion, 27a: bottom surface, 28: step portion, 31: groove, A: adhesive, C3: inscribed circle, d1, d2: maximum outer diameter, L1: length, L2: width, P1, P2, P3: center position, S: step surface, T: tape fiber.

1. An optical connector comprising:
a plurality of optical fibers each having a coating removal portion where a predetermined length of coating is removed from a tip; and
a ferrule having a main body portion holding the coating removal portion of each of the optical fibers and a lens portion facing the tip in a first direction in which an optical axis of each of the optical fibers extends, wherein
the main body portion has a base portion including a plurality of fiber grooves respectively supporting the coating removal portions of the optical fibers,
the fiber grooves extend along the first direction and are arranged along a second direction intersecting the first direction, and
the base portion has a recess portion between the fiber grooves and the lens portion in the first direction.

2. The optical connector according to claim 1, wherein
the coating removal portion includes a tip surface positioned at the tip, and
the tip surface is inclined with respect to a plane perpendicular to the first direction.

3. The optical connector according to claim 1, wherein
the coating removal portion includes:
a tip surface positioned at the tip;
a first part separated from the tip surface in the first direction; and
a second part positioned between the tip surface and the first part in the first direction and larger in maximum outer diameter than the first part,
the fiber grooves respectively support the first parts of the optical fibers, and
the recess portion accommodates the second parts of the optical fibers.

4. The optical connector according to claim 3, wherein a width of the recess portion in the first direction is larger than a length of the second part in the first direction.

5. The optical connector according to claim 1, wherein a bottom portion of the recess portion is separated from the coating removal portion in a third direction intersecting the first direction and the second direction.

6. The optical connector according to claim 1, wherein
the main body portion further has a lid portion facing the base portion with the optical fibers interposed therebetween in a third direction intersecting the first direction and the second direction, and
the lid portion is disposed in a region facing the base portion, excluding a region facing the recess portion, and facing the fiber grooves.

7. The optical connector according to claim 6, wherein
each of the optical fibers further has a coating portion where the coating remains, and
the lid portion is in contact with only the coating removal portion of the coating portion and the coating removal portion.

8. The optical connector according to claim 1, wherein an adhesive for fixing the optical fibers to the main body portion is provided in the recess portion.

9. The optical connector according to claim 1, wherein
the base portion further has a step portion on a side opposite to the recess portion with the fiber grooves interposed therebetween in the first direction,
each of the optical fibers further has a coating portion where the coating remains, and
a step surface formed between the coating portion and the coating removal portion by the coating abuts against the step portion in the first direction.

10. The optical connector according to claim 1, wherein
the lens portion includes a front end surface facing a side opposite to the base portion in the first direction and a plurality of lenses provided so as to respectively correspond to the plurality of optical fibers and protruding from the front end surface,
an outer surface of the ferrule has a groove as a reference for measuring positions of the lenses and positions of the fiber grooves viewed from the first direction, and
the groove continuously extends along the first direction over the main body portion from the lens portion.

11. The optical connector according to claim 1, wherein the recess portion is recessed in a third direction intersecting the first direction and the second direction between the fiber grooves and the lens portion in the first direction.

12. The optical connector according to claim 11, wherein a position of a bottom portion of the recess portion coincides with a position of a bottom portion of each of the fiber grooves in the third direction.

13. The optical connector according to claim 1, wherein, a tip surface of each of the optical fibers is separated from the lens portion in the first direction inside the recess portion.

14. A ferrule comprising:
a main body portion for holding a plurality of optical fibers; and
a lens portion provided at a tip side of each of the optical fibers held in the main body portion, wherein
the main body portion has a base portion including a plurality of fiber grooves for respectively supporting the optical fibers,
the fiber grooves extend along a first direction and are arranged along a second direction intersecting the first direction, and
the base portion has a recess portion between the fiber grooves and the lens portion in the first direction.

15. An optical connector manufacturing method comprising:
a step of preparing a plurality of optical fibers each having a coating removal portion where a predetermined length of coating is removed from a tip and the ferrule according to claim 14;
a step of forming a tip surface on the coating removal portion by laser-cutting the coating removal portion; and
a step of placing each of the optical fibers in each of the fiber grooves of the ferrule.

16. The optical connector manufacturing method according to claim 15, wherein, in the step of forming the tip surface, the tip surface is inclined with respect to a plane perpendicular to the first direction.

17. The optical connector manufacturing method according to claim 15, further comprising:
a step of injecting an adhesive for fixing the optical fibers to the main body portion into the recess portion after the step of placing each of the optical fibers; and
a step of disposing a lid portion so as to face the base portion with the optical fibers interposed therebetween in a third direction intersecting the first direction and the second direction after the step of injecting the adhesive into the recess portion,
wherein, in the step of disposing the lid portion, the lid portion is disposed in a region excluding a region facing the recess portion.
